(19) United States
(12) Patent Application Publication
(10) Pub. No.: US 2023/0342598 A1
(43) Pub. Date: Oct. 26, 2023

(54) ANOMALY DETECTION IN UNKNOWN DOMAINS USING CONTENT-IRRELEVANT AND DOMAIN-IRRELEVANT COMPRESSED DATA

(71) Applicant: International Business Machines Corporation, Armonk, NY (US)

(72) Inventors: Michiaki Tatsubori, Oiso (JP); Shu Morikuni, Koutouku (JP); Ryuki Tachibana, Setagaya-ku (JP); Tadanobu Inoue, Yokohama (JP)

(21) Appl. No.: 17/726,724

(22) Filed: Apr. 22, 2022

(51) Int. Cl. G06N 3/10; G06N 3/08

(52) U.S. Cl. CPC G06N 3/08; G06N 3/10

(57) ABSTRACT

Embodiments of the invention describe a computer-implemented method of detecting anomalous data associated with a system-under-analysis. The computer-implemented method includes using a first encoder stage of a neural network to generate content-irrelevant latent code from input data. A second encoder stage of the neural network is used to generate domain-irrelevant latent code from the input data. A decoder stage of the neural network is used to generate reconstructed input data. The reconstructed input data includes a reconstruction of the input data based at least in part on the content-irrelevant latent code and the domain-irrelevant latent code. A reconstruction loss is generated based at least in part on the reconstructed input data. The reconstruction loss is used to determine that the input data includes an anomalous data candidate.

### BACKGROUND

The present invention relates generally to programmable computers. More specifically, the present invention relates to programmable computer systems, computer-implemented methods, and computer program products operable to implement a neural network that detects anomalous samples in a dataset using content-irrelevant compressed data (or latent code) and domain-irrelevant compressed data (or latent code), particularly where the dataset’s domain setting is not fully known and the neural network is not trained with anomalous data.

Anomaly detection uses mathematical techniques to detect abnormalities within a dataset based on how different a given data point is from its surrounding data points or from a standard deviation. For example, the abnormality can be data that does not conform to an expected pattern or to other items in a dataset. Anomaly detection techniques can be applied to data collection systems (DCSs) that gather data from a variety of environments, including, for example, product quality inspection systems, equipment maintenance operations, network intrusion detection systems, fraud detection systems, and the like.

Anomaly detection techniques can be implemented using anomaly detection (AD) algorithms coupled to or integrated within a DCS. Some AD algorithms utilize an autoencoder, which is a type of neural network that learns how to efficiently compress and encode original data to a lower dimensional space known as “latent code” then learns how to decompress the latent code to a representation of the original data (i.e., “reconstructed” original data) that is as close to the original data input as possible. The differences between the original data input and the reconstructed data output can be used to create encoded rules for expected output and vice versa. Post-training, the autoencoder can flag as anomalous data values that fall outside of the encoded rules.

### SUMMARY

Embodiments of the invention provide a computer-implemented method of detecting anomalous data associated with a system-under-analysis. The computer-implemented method includes using a first encoder stage of a neural network to generate content-irrelevant latent code from input data. A second encoder stage of the neural network is used to generate domain-irrelevant latent code from the input data. A decoder stage of the neural network is used to generate reconstructed input data. The reconstructed input data includes a reconstruction of the input data based at least in part on the content-irrelevant latent code and the domain-irrelevant latent code. A reconstruction loss is generated based at least in part on the reconstructed input data. The reconstruction loss is used to determine that the input data includes an anomalous data candidate.

Embodiments of the invention further provide computer systems and computer program products having substantially the same features as the above-described computer-implemented method.

Additional features and advantages are realized through the techniques described herein. Other embodiments and aspects are described in detail herein. For a better understanding, refer to the description and to the drawings.

### BRIEF DESCRIPTION OF THE DRAWINGS

The subject matter which is regarded as the present invention is particularly pointed out and distinctly claimed in the claims at the conclusion of the specification. The foregoing and other features and advantages are apparent from the following detailed description taken in conjunction with the accompanying drawings in which:

FIG. 1 depicts a simplified diagram of input and output connections of a biological neuron, which is a template for a deep-learning neural network architecture that implements aspects of the invention;

FIG. 2 depicts a simplified diagram illustrating a mathematical model inspired by the simplified biological neuron diagram shown in FIG. 1;

FIG. 3 depicts a simplified diagram illustrating a neural network layer architecture that incorporates the mathematical model shown in FIG. 2 and is a basic neural network framework that implements aspects of the invention;

FIG. 4 depicts a block diagram of a non-limiting example of an unknown domain having a content-irrelevant & domain-irrelevant (CIDI) neural network embodying aspects of the invention;

FIG. 5 depicts a block diagram of an anomaly detection system having a CIDI neural network embodying aspects of the invention;

FIG. 6 depicts a block diagram illustrating functional features of the CIDI neural network shown in FIG. 5;

FIG. 7 depicts a flow diagram illustrating a methodology for training the CIDI neural network shown in FIG. 5 in accordance with aspects of the invention;

FIG. 8 depicts a flow diagram illustrating a methodology implemented by the CIDI neural network shown in FIG. 5 in accordance with aspects of the invention;

FIG. 9 depicts a block diagram illustrating a non-limiting example implementation of the CIDI neural network shown in FIG. 5 as a novel CIDI autoencoder in accordance with aspects of the invention;

FIG. 10 depicts a block diagram illustrating how the domain disentanglement and the content disentanglement functionalities of the CIDI autoencoder shown in FIG. 9 can each be implemented using an adversarial discriminator in accordance with aspects of the invention;

FIG. 11 depicts a block diagram illustrating how the self-supervised domain pre-classification and the self-supervised content pre-classification functionalities of the CIDI autoencoder shown in FIG. 9 can each be implemented using a classifier in accordance with aspects of the invention;

FIG. 12 depicts a block diagram illustrating learning phase functionality that can be used by the CIDI neural network and/or the CIDI autoencoder shown in FIGS. 4 and 8 in accordance with aspects of the invention;

FIG. 13 depicts a programmable computer system capable of implementing aspects of the invention;

FIG. 14 depicts a cloud computing environment according to embodiments of the present invention; and

FIG. 15 depicts abstraction model layers according to an embodiment of the present invention.

In the accompanying figures and following detailed description of the disclosed embodiments, the various elements illustrated in the figures are provided with three-digit reference numbers. The leftmost digit of each reference number corresponds to the figure in which its element is first illustrated.

### DETAILED DESCRIPTION

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Many of the functional units described in this specification are illustrated as logical blocks such as encoders, decoders, classifiers, discriminators, modules, processors, and the like. Embodiments of the invention apply to a wide variety of implementations of the logical blocks described herein. For example, a given logical block can be implemented as a hardware circuit operable to include custom VLSI circuits or gate arrays, as well as off-the-shelf semiconductors such as logic chips, transistors, or other discrete components. The logical blocks can also be implemented in programmable hardware devices such as field programmable gate arrays, programmable array logic, programmable logic devices, and the like. The logical blocks can also be implemented in software for execution by various types of processors. Some logical blocks described herein can be implemented as one or more physical or logical blocks of computer instructions which can, for instance, be organized as an object, procedure, or function. The executables of a logical block described herein need not be physically located together but can include disparate instructions stored in different locations which, when joined logically together, include the logical block and achieve the stated purpose for the logical block.

Turning now to a more detailed description of technologies related to aspects of the invention, as previously noted herein, data collections systems (DCSs) are used to gather data from a variety of environments, including, for example, product quality inspection systems, equipment maintenance operations, network intrusion detection systems, fraud detection systems, and the like. With the proliferation of analytics programs and various management software, it is now easier than ever for companies to effectively use DCSs to measure every single aspect of business activity, including, for example, the operational performance of applications and infrastructure components, as well as key performance indicators (KPIs) that evaluate the success of the organization. With millions of metrics that can be measured, companies can generate very large datasets from which insights can be gained about the performance of their business through applying the appropriate analysis technique(s) to the datasets.

Within DCS datasets are data patterns that represent normal operation of the relevant business operation or system. An unexpected change within these data patterns, or an event that does not conform to the expected data pattern, is considered an anomaly. As previously noted herein, anomaly detection uses mathematical techniques to detect abnormalities within a dataset (e.g., a DCS dataset) based on how different a given data point is from its surrounding data points or from a standard deviation. For example, the abnormality can be data that does not conform to an expected pattern or to other items in a dataset. In some situations, data that changes significantly is non-anomalous if it follows an expected pattern. For example, there is nothing unusual about an eCommerce website collecting a large amount of revenue on a Cyber Monday sale day. In some situations, the absence of data changes can be an anomaly if it breaks a pattern that is normal for the data from that particular metric. Anomalies represent deviations from the expected value for a metric at a given point in time and generally require additional downstream analysis to determine whether the anomalous behavior is good or bad.

Anomaly detection tasks can be performed by neural networks using deep learning algorithms. Known deep learning algorithms require large amounts of labeled (annotated) data to train effective models for the performance of cognitive operations such as prediction, classification, and the like. However, in many anomaly detection deep learning applications, labeled anomalous training data is not available or not abundant due to a variety of factors. For example, where the anomaly detection application is monitoring acoustic sound from a vehicle to detect anomalous acoustic sounds (e.g., brakes squeaking at a certain pitch/frequency) that could represent a potential or imminent vehicle malfunction, the anomaly detection neural network will be trained using non-anomalous data from certain vehicles under certain operating circumstances, and this non-anomalous training data will be different from any anomalous data generated by a different vehicle operating under different circumstances during actual runtime of the neural network. The differences between training vehicles and runtime vehicles can include the make/model of the vehicle, the vehicle features (e.g., all-wheel drive vs. four-wheel drive), vehicle accessory packages, and the like. The differences between training operating circumstances and runtime operating circumstance can include the driving habits of the vehicle operator, the weather, road conditions, ambient sounds (e.g., driving through a tunnel, music playing in the vehicle cabin, etc.), and the like.

So-called “zero-shot” learning techniques have been developed to train machine learning algorithms to perform runtime classification or prediction tasks where the machine learning algorithm has not previously seen or been trained with examples of the actual runtime classification/prediction. In other words, zero-shot learning can enable a machine algorithm to perform classification/prediction tasks where examples of the actual runtime classification/prediction tasks are “unknown” to the machine learning algorithm(s). Runtime data can include content-related features and domain-related features. In the above-described vehicle example, the characteristics of the acoustic sound (e.g., pitch, tone, loudness, etc.) are considered the “content” features of the runtime data; and the context characteristics of the runtime acoustic sound (vehicle make/model, weather, road conditions, driving habits of the vehicle operator, driving through tunnels, etc.) are considered the “domain” features of the runtime data. In this detailed description, the term “unknown” refers to situations where training data of the content and domain in which a neural network will attempt to classify runtime data is not available in sufficient quantities for effective training of a deep learning neural network.

In zero-shot learning, the classes covered by training instances and the classes that the runtime task aims to classify are disjoint. Thus, zero-shot learning techniques are designed to overcome the lack of training examples in the runtime task by leveraging details learned from training examples of a task that is related to but different from the runtime task. The details learned from training examples of the related/different task are used to draw inferences about the unknown classes of the runtime task because both the training classes and the unknown runtime task classes are related in a high dimensional vector space called semantic space. Thus, known zero-shot learning techniques can include a training stage and an inference stage. In the training stage, knowledge about the attributes of intermediate semantic layers is captured; and in the inference stage, this knowledge is used to categorize instances among a new set of classes.

It would be beneficial to provide zero-shot semi-supervised anomaly detection systems having improved ability to exploit the discriminative capacity of attributes, thereby improving anomaly detection tasks performed in unknown domains.

Turning now to an overview of aspects of the invention, embodiments of the invention provide programmable computer systems, computer-implemented methods, and computer program products operable to implement a neural network that detects anomalous samples in a dataset using content-irrelevant compressed data and domain-irrelevant compressed data, particularly where the dataset’s domain setting is not fully known and the neural network is not trained with anomalous data. In this detailed description, anomalous samples include sampled data that does not conform to an expected pattern or to other items in the relevant sampled dataset. Continuing here with the previously-described vehicle example, the characteristics of the acoustic sound (e.g., pitch, tone, loudness, etc.) are included among the “content” features of the runtime data; and the context characteristics of the runtime acoustic sound (vehicle make/model, weather, road conditions, driving habits of the vehicle operator, driving through tunnels, etc.) are included among the “domain” features of the runtime data. In this detailed description, the term “unknown” refers to situations where training data of the content and domain in which a neural network will attempt to classify runtime data is not available in sufficient quantities for effective training of a deep learning neural network.

A neural network configured and trained in accordance with aspects of the invention isolates content-irrelevant compressed data and domain-irrelevant compressed data from data representing acoustic sound emanating from a vehicle during operation. Embodiments of the invention implement novel zero-shot learning techniques that train the neural network to leverage content-irrelevant compressed data and domain-irrelevant compressed data in a manner that improves the neural network’s ability to perform runtime classification or prediction tasks where the neural network has not previously seen or been trained with examples of the actual runtime classification/prediction (i.e., examples of runtime anomalous data). The generation of content-irrelevant compressed data and domain-irrelevant compressed data in accordance with aspects of the invention improves the neural network’s ability to perform classification/prediction tasks where the domain of examples of the actual runtime classification/prediction tasks are “unknown” to the neural network. Accordingly, the data used to train the neural network in accordance with embodiments of the invention can be labeled datasets representing similar but different content features, as well as similar but different domain features.

In accordance with aspects of the invention, the trained neural network includes an encoder that receives data representing the acoustic sounds generated by the vehicle during runtime (i.e., runtime input data). The runtime input data includes content-related features and domain-related features, both of which are leveraged by embodiments of the invention. The encoder includes a first encoder stage and a second encoder stage. Each of the first and second encoder stages is operable to compress the input runtime data into increasingly lower dimensions to extract the essence of the relationships between the runtime data instances. The compressed input runtime data is known as latent code. The first encoder stage generates a first instance of latent code (i.e., first latent code), and the second encoder stage generates a second instance of latent code (i.e., second latent code). The neural network is trained to perform a content disentanglement operation on the first latent code to disentangle content latent code from the first latent code, thereby suppressing domain information to be included in the first latent code that only includes the domain-irrelevant features of the runtime input data. The neural network is further trained to perform a domain disentanglement operation on the second latent code to disentangle domain latent code from the second latent code, thereby suppressing content information to be included in the second latent code that only includes the content-irrelevant features of the runtime input data. Suppressing the domain/content information in the latent content/domain code can be done by adversarial training (i.e., penalize if the classifier detects the domain/content from the code successfully). In some aspects of the invention, after the content and domain disentanglement operations, the remaining latent code, if any, is content-irrelevant and domain-irrelevant.

In some embodiments of the invention, the domain latent code is further processed by performing a self-supervised domain pre-classification operation on the domain latent code to group similar instances of domain latent code together. Similarly, in some embodiments of the invention, the content latent code is further processed by performing a self-supervised content pre-classification operation on the content latent code to group similar instances of content latent code together. The above-described pre-classification operations can be implemented as contrastive learning techniques operable to allow domain code and content code to each be contrastive, which means providing embedding spaces for each in which similar samples stay close to each other while dissimilar ones are far apart.

The domain latent code, the content-irrelevant and domain-irrelevant (CIDI) latent code (if any), and the content latent code are combined and provided to a decoder that decompresses the combined latent codes to generate output runtime data that is an attempt to reproduce the input runtime data. Any differences between input runtime data and the output runtime data are captured by the neural network as a reconstruction loss that is used to train the neural network. Once the neural network is trained, the reconstruction loss can be analyzed by the neural network or downstream circuitry to determine that input runtime data associated with the reconstruction loss is anomalous.

In some embodiments of the invention, the neural network can be implemented as an autoencoder operable to include the first encoder stage, the second encoder stage, content disentanglement functionality, and domain disentanglement functionality. In some embodiments of the invention, the neural network can be implemented as an autoencoder operable to include the first encoder stage, the second encoder stage, content disentanglement functionality, domain pre-classification functionality, domain disentanglement functionality, and content pre-classification functionality. In some embodiments of the invention, the content disentanglement functionality can be implemented as an adversarial content discriminator configured and trained to perform the task of disentangling content features from the first latent code to generate the domain latent code. In some embodiments of the invention, the domain disentanglement functionality can be implemented as an adversarial domain discriminator configured and trained to perform the task of disentangling domain features from the second latent code to generate the content latent code. In some embodiments of the invention, the domain pre-classification functionality can be implemented using a domain classifier configured and trained to use contrastive learning techniques that learn the general features of a dataset without labels by teaching the neural network model which data points are similar or different. In essence, contrastive learning allows a neural network model looks at which pairs of data points are “similar” and “different” in order to learn higher-level features about the data before even having a task such as classification or segmentation. The allows the neural network model to be trained to learn a lot about the data without any annotations or labels, hence the term, self-supervised learning.

Embodiments of the invention can be trained to perform a variety of tasks, including, for example, e.g. anomaly detection, translation, visualization, finding association rules, clustering, the like.

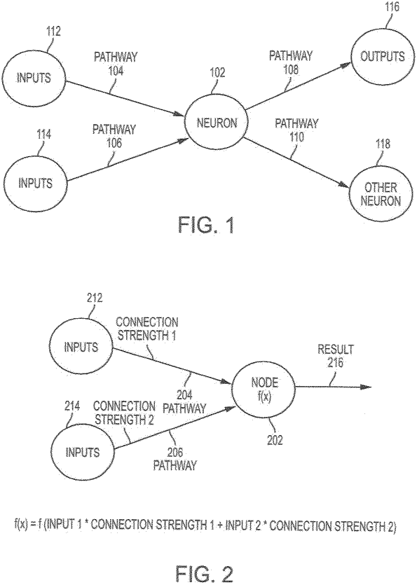

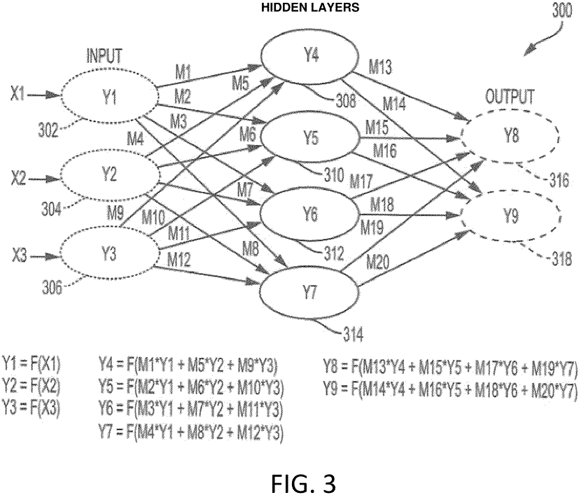

Turning now to a more detailed description of aspects of the invention, FIGS. 1-3 depict various features of a neural network architecture 300 (shown in FIG. 3) capable of implementing aspects of the invention. More specifically, FIG. 1 depicts a simplified diagram of input and output connections 112, 114, 116, 118 of a biological neuron 102, which provides a template for the neural network architecture 300. FIG. 2 depicts a simplified model of the biological neuron 102 shown in FIG. 1. FIG. 3 depicts a simplified neural network layer architecture 300 that incorporates the biological neuron model shown in FIG. 2.

Turning to FIG. 1, there is depicted a simplified diagram of the biological neuron 102 having pathways 104, 106, 108, 110 that connect it to upstream inputs 112, 114, downstream outputs 116, and downstream “other” neurons 118, configured and arranged as shown. Each biological neuron 102 sends and receives electrical impulses through pathways 104, 106, 108, 110. The nature of these electrical impulses and how they are processed in biological neuron 102 are primarily responsible for overall brain functionality. The pathway connections 104, 106, 108, 110 between the biological neurons 102, 118 can be strong or weak. When the neuron 102 receives input impulses, the neuron 102 processes the input according to the neuron’s function and sends the result of the function on pathway 108 to downstream outputs 116 and/or on pathway 110 to downstream “other” neurons 118. A normal adult human brain includes about one hundred billion interconnected neurons.

In FIG. 2, the biological neuron 102 (shown in FIG. 1) is modeled as a node 202 having a mathematical function, f(x), depicted by the equation shown in FIG. 2. Node 202 receives electrical signals from inputs 212, 214, multiplies each input 212, 214 by the strength of its respective connection pathway 204, 206, takes a sum of the inputs, passes the sum through a function, f(x), and generates a result 216, which may be a final output or an input to another node, or both. In the present specification, an asterisk (*) is used to represent a multiplication. Weak input signals are multiplied by a very small connection strength number, so the impact of a weak input signal on the function is very low. Similarly, strong input signals are multiplied by a higher connection strength number, so the impact of a strong input signal on the function is larger. The function f(x) is a design choice, and a variety of functions can be used. A suitable design choice for f(x) is the hyperbolic tangent function, which takes the function of the previous sum and outputs a number between minus one and plus one.

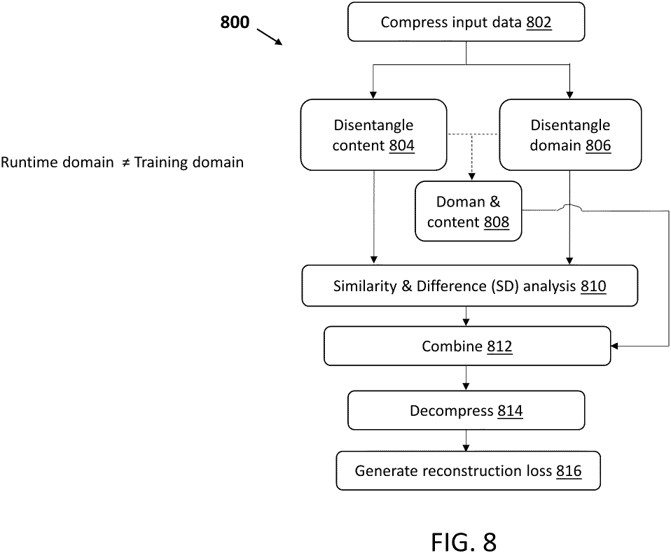

FIG. 3 depicts a simplified neural network architecture (or model) 300. In general, neural networks can be implemented as a set of algorithms running on a programmable computer (e.g., computer systems 800 shown in FIG. 8). In some instances, neural networks are implemented on an electronic neuromorphic machine (e.g., the IBM®/DARPA SyNAPSE computer chip) that attempts to create connections between processing elements that are substantially the functional equivalent of the synapse connections between brain neurons. In either implementation, neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical). The basic function of a neural network is to recognize patterns by interpreting sensory data through a kind of machine perception. Real-world data in its native form (e.g., images, sound, text, or time series data) is converted to a numerical form (e.g., a vector having magnitude and direction) that can be understood and manipulated by a computer. The neural network is “trained” by performing multiple iterations of learning-based analysis on the real-world data vectors until patterns (or relationships) contained in the real-world data vectors are uncovered and learned.

Neural networks use feature extraction techniques to reduce the number of resources required to describe a large set of data. The analysis on complex data can increase in difficulty as the number of variables involved increases. Analyzing a large number of variables generally requires a large amount of memory and computation power. Additionally, having a large number of variables can also cause a classification algorithm to over-fit to training samples and generalize poorly to new samples. Feature extraction is a general term for methods of constructing combinations of the variables in order to work around these problems while still describing the data with sufficient accuracy.

Although the patterns uncovered/learned by a neural network can be used to perform a variety of tasks, two of the more common tasks are labeling (or classification) of real-world data and determining the similarity between segments of real-world data. Classification tasks often depend on the use of labeled datasets to train the neural network to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, the like. Similarity tasks apply similarity techniques and (optionally) confidence levels (CLs) to determine a numerical representation of the similarity between a pair of items.

Returning again to FIG. 3, the simplified neural network architecture/model 300 is organized as a weighted directed graph, wherein the artificial neurons are nodes (e.g., 302, 308, 316), and wherein weighted directed edges (e.g., m1 to m20) connect the nodes. The neural network model 300 is organized such that nodes 302, 304, 306 are input layer nodes, nodes 308, 310, 312, 314 are hidden layer nodes, and nodes 316, 318 are output layer nodes. Each node is connected to every node in the adjacent layer by connection pathways, which are depicted in FIG. 3 as directional arrows having connection strengths m1 to m20. For ease of illustration and explanation, one input layer, one hidden layer, and one output layer are shown in FIG. 3. However, in practice, multiple input layers, multiple hidden layers, and multiple output layers can be provided. When multiple hidden layers are provided, the neural network model 300 can perform unsupervised deep-learning for executing classification/similarity type tasks.

Similar to the functionality of a human brain, each input layer node 302, 304, 306 of the neural network 300 receives inputs x1, x2, x3 directly from a source (not shown) with no connection strength adjustments and no node summations. Accordingly, y1 = f(x1), y2 = f(x2) and y3 = f(x3), as shown by the equations listed at the bottom of FIG. 3. Each hidden layer node 308, 310, 312, 314 receives its inputs from all input layer nodes 302, 304, 306 according to the connection strengths associated with the relevant connection pathways. Thus, in hidden layer node 308, y4 = f (m1*y1 + m5*y2 + m9*y3), wherein * represents a multiplication. A similar connection strength multiplication and node summation is performed for hidden layer nodes 310, 312, 314 and output layer nodes 316, 318, as shown by the equations defining functions y5 to y9 depicted at the bottom of FIG. 3.

The neural network model 300 processes data records (or other forms of electronic information) one at a time, and it “learns” by comparing an initially arbitrary classification of the record with the known actual classification of the record. Using a training methodology knows as “back-propagation” (i.e., “backward propagation of errors”), the errors from the initial classification of the first record are fed back into the network and used to modify the network’s weighted connections the second time around, and this feedback process continues for many iterations. In the training phase of a neural network, the correct classification for each record is known, and the output nodes can therefore be assigned “correct” values. For example, a node value of “1” (or 0.9) for the node corresponding to the correct class, and a node value of “0” (or 0.1) for the others. It is thus possible to compare the network’s calculated values for the output nodes to these “correct” values, and to calculate an error term for each node (i.e., the “delta” rule). These error terms are then used to adjust the weights in the hidden layers so that in the next iteration the output values will be closer to the “correct” values.

There are many types of neural networks, but the two broadest categories are feed-forward neural networks and recurrent neural networks. The neural network model 300 is a non-recurrent feed-forward network having inputs, outputs and hidden layers. The signals can only travel in one direction. Input data is passed onto a layer of processing elements that perform calculations. Each processing element makes its computation based upon a weighted sum of its inputs. The new calculated values then become the new input values that feed the next layer. This process continues until it has gone through all the layers and determined the output. A threshold transfer function is sometimes used to quantify the output of a neuron in the output layer.

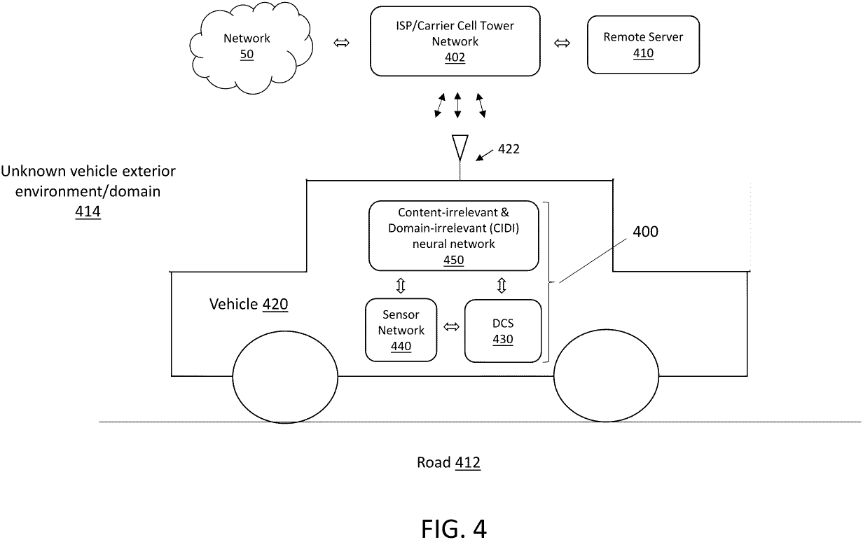

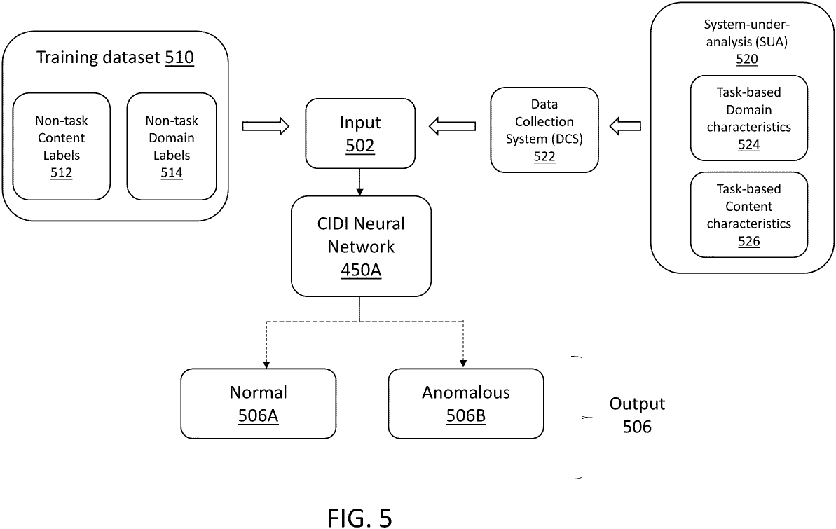

Turning now to a more detailed description of embodiments of the present invention, FIG. 4 depicts a diagram anomaly detection system 100 operable to include aspects of the present invention. The system 100 can be included in any environment or domain where it is desirable to detect anomalous data within a dataset generated by a DCS. In the non-limiting example depicted in FIG. 1, the system 100 has been integrated into a vehicle 120, and FIG. 4 depicts the vehicle 120 in-use and traveling on a road 112 in an unknown vehicle exterior environment/domain 414. The vehicle 120 includes an antenna system 122 that places the vehicle 120 in communication with an ISP/carrier cell tower network 402, a remote sever 410, and a cloud computing system 50, configured and arranged as shown. In accordance with aspects of the invention, the system 100 includes a content-irrelevant and domain-irrelevant (CIDI) neural network 450 communicatively coupled to a sensor network 440 and a DCS 430. In accordance with aspects of the invention, the CIDI neural network 450 is operable to detect anomalous samples in a dataset of the DCS 430 using content-irrelevant compressed data and domain-irrelevant compressed data, particularly where the dataset’s domain setting is not fully known and the CIDI neural network 450 is not trained with anomalous data. Additional details of how the CIDI neural network 450 can be implemented in accordance with aspects of the invention are depicted in FIGS. 5-15 and described in greater detail subsequently herein.

In aspects of the invention, the DCS 430 can include sufficient processing power (e.g., computing system 800 shown in FIG. 8) to gather, store, and analyze operating data of the vehicle 120. In some embodiments of the invention, the DCS 430 can gather and store operating data of the vehicle 120, and then transmits the operating data, using antenna system 122, through the ISP/Carrier cell tower network 402 to either cloud computing system 50 or remote server 410 for analysis.

In some embodiments of the invention, the DCS 430 includes an on-board diagnostics (OBD) system/module, along with an electronic control unit (ECU). The OBD system can be implemented as a computer-based system that monitors various vehicle subsystems (e.g., the performance of major engine components of vehicle 120). A basic configuration for the OBD system includes an ECU, which uses input from the sensor system network 440 to control features of the vehicle 120 in order to reach the desired performance. Known OBD modules/systems can support hundreds of sensors that sense hundreds of parameters, which can be accessed via a diagnostic link connector (not shown) using a device called a scan tool (not shown). Accordingly, the OBD system and the sensor system 440 cooperate to generate sensed operating data about how the vehicle 120 is performing in operation. Data can be gathered from, for example, brake assist systems, forward-collision warning systems, automatic emergency braking systems, adaptive cruise control systems, blind-spot warning systems, rear cross-traffic alert systems, lane-departure warning systems, lane-keeping assist systems, pedestrian detection systems, and the like.

The sensor system 440, in accordance with embodiments of the invention, gathers vehicle state sensed data. Vehicle state sensed data includes but is not limited to data about acoustic sounds emanating from the vehicle 120 during operation, the vehicle’s route, duration of trips, number of times started/stopped, speed, speed of acceleration, speed of deceleration, use of cruise controls, the wear and tear on its components, and even road conditions and temperatures (engine and external) of the unknown vehicle exterior environment/domain 414. The sensors that form the sensor system 440 are chosen to provide the data needed to measure selected parameters. For example, microphones are provided to capture acoustic sounds. Throttle positions sensors are provided to measure throttle position. G-analyst sensors are provided to measure g-forces.

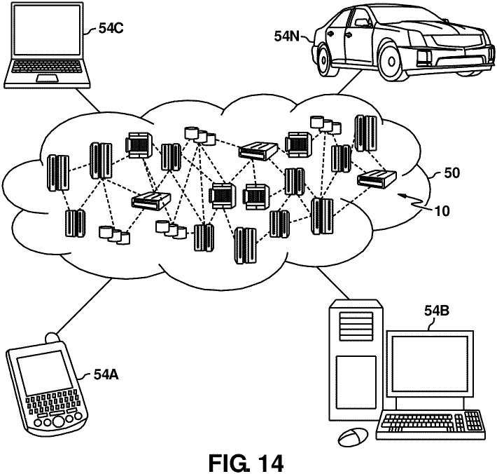

Cloud computing system 50 is in wired or wireless electronic communication with one or all of remote server 410, cell tower network 402, antenna system 122, and DCS 430. Cloud computing system 50 can supplement, support, or replace some or all of the functionality of remote server 410, cell tower network 402, antenna system 122, and DCS 430. Additionally, some or all of the functionality of remote server 410, cell tower network 402, antenna system 122, and DCS 430 can be implemented as a node 10 (shown in FIG. 14) of cloud computing system 50.

The various internal and external vehicle components/modules shown in FIG. 4 are depicted separately for ease of illustration and explanation. In embodiments of the invention, the functions performed by the various internal and external vehicle components/modules can be distributed differently than shown. For example, the CIDI neural network 450 could be integrated into DCS 430 and/or the remote server 410.

FIG. 5 depicts an example of how the CIDI neural network 450 (shown in FIG. 4) can be implemented as CIDI neural network 450A. Inputs 402 are provide the CIDI neural network 450A. During training, the input 502 is training input data received from a training dataset 510. In some embodiments of the invention, the training dataset 510 can be labeled with non-task content labels 512 and/or non-task domain labels 514. In this detailed description, the term “task” is used to describe a task to be performed by the CIDI neural network 450A in the field. In some embodiments of the invention, the task is to detect anomalous data in a dataset. Accordingly, the non-task content labels 512 and/or the non-task domain labels 514 represent labels that are not examples of the anomalous data that the CIDI neural network 450A has been tasked to classify or predict.

During runtime, the inputs 502 are runtime input data received from a DCS 522 operable to gather runtime input data from a system-under-analysis (SUA) 520. The SUA 520 includes task-based domain characteristics 524 and/or task-based content characteristics 526. Accordingly, the runtime input data from the DCS 522 also reflects the task-based domain characteristics 524 and/or the task-based content characteristics 526. As previously noted, the term “task” is used to describe a task to be performed by the CIDI neural network 450A in the field. In some embodiments of the invention, the task is to detect anomalous data in a dataset. Accordingly, the task-based domain characteristics 524 and/or the task-based content characteristics 526 represent characteristics that include actual anomalous data that the CIDI neural network 450A has been tasked to classify or predict.

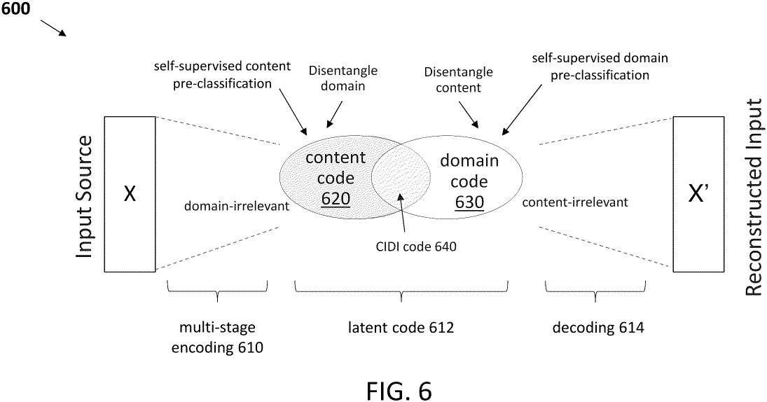

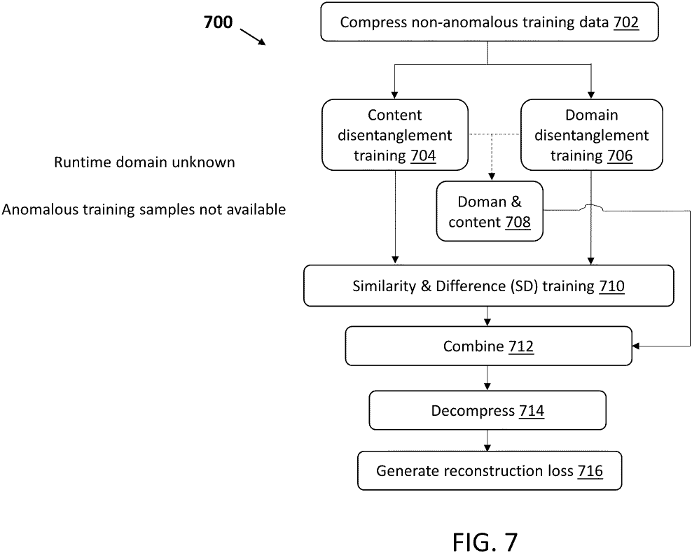

In accordance with aspects of the invention, a novel zero-shot training methodology (shown in FIGS. 6 and 7) is used to train the CIDI neural network 450A, using the training dataset 510, to generate output 506 that is accurately classified as either normal 506A (i.e., non-anomalous) or anomalous 506B. In accordance with aspects of the invention, and as will be described in greater detail in connection with the descriptions of FIGS. 6 and 7, the novel zero-shot training methodology trains the CIDI neural network 450A to use content-irrelevant compressed data and domain-irrelevant compressed data, particularly where the task-based domain characteristics 524 are not fully known and the CIDI neural network 450A is not trained with anomalous data. In this detailed description, anomalous samples include sampled data that does not conform to an expected pattern or to other items in the relevant dataset. In embodiments of the invention where the SUA 520 is the vehicle 120 (shown in FIG. 4), the characteristics of the runtime acoustic sound (e.g., pitch, tone, loudness, etc.) are included among the task-based content characteristics 526; and the context characteristics of the runtime acoustic sound (vehicle make/model, weather, road conditions, driving habits of the vehicle operator, driving through tunnels, etc.) are included among the task-based domain characteristics 524. In this detailed description, the term “unknown” refers to situations where training data that represents the task-based domain characteristics 524 and the task-based content characteristics 526 are not available in sufficient quantities for effective training of the CIDI neural network 450A.

FIG. 6 depicts a combined block/flow diagram illustrating a zero-shot training methodology 600 utilized by the CIDI neural network 450A (shown in FIG. 5) in accordance with aspects of the invention. The zero-shot training methodology 600 uses known zero-shot training techniques that further include the functions and features depicted in methodology 600. As shown, the CIDI neural network 450A applies multi-stage encoding 610 to input source X. One stage of the multi-stage encoding 610 generates a first instance of the latent code 612 to which a domain disentanglement process and (optionally) an un-supervised content pre-classification process are applied to generate content code 620 that is domain-irrelevant. Another stage of the multi-stage encoding 610 generates a second instance of the latent code 612 to which a content disentanglement process and (optionally) an un-supervised domain pre-classification process are applied to generate domain code 630 that is content-irrelevant. The portions, if any, of the first and second instances of the latent code 612 that cannot be disentangled are content-irrelevant and domain-irrelevant (CIDI) code 640. In accordance with aspects of the invention, CIDI code 640 is irrelevant to the content code 620 and the domain code 630. However, the CIDI code 640 is needed by the decoding 614, which uses the combined, content code 620, domain code 630, and CIDI code 640 to generate the reconstructed input X′ having a reconstruction loss. The decoding 614 is applied to the combined, content code 620, domain code 630, and CIDI code 640 to train the CIDI neural network 450A (shown in FIG. 5) with its reconstruction loss. The trained CIDI neural network 450A can be used for classification confidence-based anomaly detection and/or or reconstruction error-based anomaly detection.

In some embodiments of the invention, the domain disentanglement functionality can be implemented as an adversarial content discriminator configured and trained to perform the task of disentangling domain code from the first instance of the latent code 612 to generate the content code 620. In some embodiments of the invention, the content disentanglement functionality can be implemented as an adversarial content discriminator configured and trained to perform the task of disentangling content features from the second instance of the latent code 612 to generate the domain code 630. In some embodiments of the invention, the self-supervised pre-classification functionalities (content pre-classification and domain pre-classification) can each be implemented using a classifier (a content classifier and a domain classifier) configured and trained to use contrastive learning techniques that learn the general features of a dataset without labels by teaching the neural network model which data points are similar or different. In essence, contrastive learning allows a neural network model looks at which pairs of data points are “similar” and “different” in order to learn higher-level features about the data before even having a task such as classification or segmentation. This allows the neural network model to be trained to learn a lot about the data without any annotations or labels, hence the term, self-supervised learning.

FIG. 7 depicts a flow diagram illustrating a zero-shot training methodology 700 in accordance with embodiments of the invention. The methodology 700 is implemented by the by the CIDI neural network 450A (shown in FIG. 5) in accordance with aspects of the invention. The zero-shot training methodology 700 uses known zero-shot training techniques that further include the functions and features depicted in methodology 700. At block 702, the CIDI neural network 450A compresses non-anomalous training data and routes instances of the compressed non-anomalous training data to block 704 and block 706. In some embodiments of the invention, the non-anomalous training data is labeled with content labels and domain labels. At block 704, content disentanglement training is applied to a first instance of the compressed non-anomalous training data to generate domain code that is irrelevant to content features of the non-anomalous training data. At block 706, domain disentanglement training is applied to a second instance of the compressed non-anomalous training data to generate content code that is irrelevant to domain features of the non-anomalous training data. Portions of the first and second instances of the compressed non-anomalous training data that are not disentangled at blocks 704 and/or 706, if any, are provided to block 708 as content and domain (C/D) relevant code. The domain code generated at block 704 and the content code generated at block 706 are provide to block 710 where similarity and difference (S/D) training is applied to identify similarities and differences among the domain code and the content code. The outputs of blocks 708 (if any) and 710 are combined at block 712 then decompressed at block 714 in an attempt to reconstruct the non-anomalous training data compressed at block 702. Block 716 extracts a reconstruction loss from the decompressed data generated at block 714, and the reconstruction loss is used to train CIDI neural network 450A.

In some embodiments of the invention, the content disentanglement functionality at block 704 can be implemented as an adversarial content discriminator configured and trained to perform the task of disentangling domain code from the first instance of the compressed non-anomalous training data to generate the content code that is domain irrelevant. In some embodiments of the invention, the domain disentanglement functionality at block 706 can be implemented as an adversarial domain discriminator configured and trained to perform the task of disentangling domain features from the second instance of the compressed non-anomalous training data to generate domain code that is content irrelevant. In some embodiments of the invention, the S/D training applied at block 710 can be implemented using a classifier (a content classifier and a domain classifier) configured and trained to use contrastive self-learning techniques that learn the general features of a dataset without labels by teaching the neural network model which data points are similar or different. In essence, contrastive self-learning allows a neural network model looks at which pairs of data points are “similar” and “different” in order to learn higher-level features about the data before even having a task such as classification or segmentation. This allows the neural network model to be trained to learn a lot about the data without any annotations or labels, hence the term, self-supervised learning.

FIG. 8 depicts a flow diagram illustrating an anomalous data detection methodology 700 in accordance with embodiments of the invention. The methodology 700 is implemented by the by the CIDI neural network 450A (shown in FIG. 5), which has been trained using one of the zero-shot training methods 600, 700 (shown in FIGS. 6 and 7) in accordance with aspects of the invention. At block 702, the CIDI neural network 450A compresses input data, which can include non-anomalous and anomalous data, and routes instances of the compressed input data to block 704 and block 706. At block 704, content disentanglement training is applied to a first instance of the compressed input data to generate domain code that is irrelevant to content features of the input data. At block 706, domain disentanglement training is applied to a second instance of the compressed input data to generate content code that is irrelevant to domain features of the input data. Portions of the first and second instances of the compressed input data that are not disentangled at blocks 704 and/or 706, if any, are provided to block 708 as content and domain (C/D) relevant code. The domain code generated at block 704 and the content code generated at block 706 are provide to block 710 where similarity and difference (S/D) analysis is applied to identify similarities and differences among the domain code and the content code. The outputs of blocks 708 (if any) and 710 are combined at block 712 then decompressed at block 714 in an attempt to reconstruct the input data compressed at block 702. Block 716 extracts a reconstruction loss from the decompressed data generated at block 714, and the reconstruction loss is used by the CIDI neural network 450A to identify anomalous data.

In some embodiments of the invention, the content disentanglement functionality at block 704 can be implemented as an adversarial content discriminator configured and trained to perform the task of disentangling domain code from the first instance of the compressed input data to generate the content code that is domain irrelevant. In some embodiments of the invention, the domain disentanglement functionality at block 706 can be implemented as an adversarial domain discriminator configured and trained to perform the task of disentangling domain features from the second instance of the compressed input data to generate domain code that is content irrelevant. In some embodiments of the invention, the S/D analysis applied at block 710 can be implemented using a classifier (a content classifier and a domain classifier) configured and trained to use contrastive self-learning techniques that have been trained to learn the general features of a dataset without labels by teaching the neural network model which data points are similar or different. In essence, contrastive self-learning allows a neural network model looks at which pairs of data points are “similar” and “different” in order to learn higher-level features about the data before even having a task such as classification or segmentation. This allows the neural network model to be trained to learn a lot about the data without any annotations or labels, hence the term, self-supervised learning.

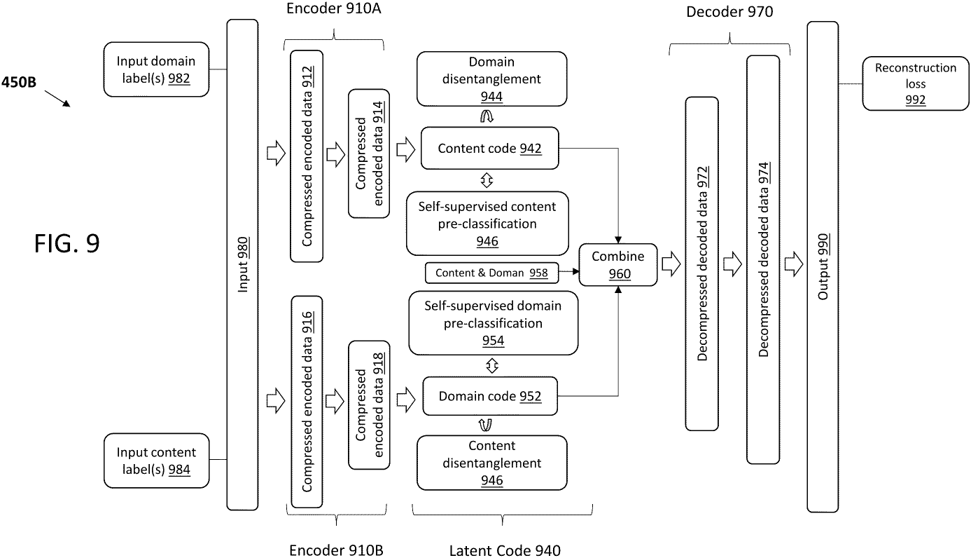

FIG. 9 depicts a CIDI neural network 450B in accordance with aspects of the invention. The CIDI neural network 450B is an example implementation of the CIDI neural networks 450, 450A (shown in FIGS. 4 and 5). In accordance with embodiments of the invention, the CIDI neural network 450B can be trained using the novel zero-shot training methodologies 600, 700 (shown in FIGS. 6 and 7), and can be operated, post-training, using the anomalous data detection methodology 800 (shown in FIG. 8). The CIDI neural network 450B includes a first encoder stage 910A, a second encoder stage 910B, a latent code stage 940, and a decoder stage 970. The first encoder stage 910A receives a first instance of the input 980 and performs multiple successive compressions or encodings to generate compressed encoded data 912 and compressed encoded data 914. Although only two instances of compressed encoded data 912, 914 are shown, any number of successive compressions or encodings can be employed until a desired lower dimension space for the latent code 940 is reached. The second encoder stage 910B receives a second instance of the input 980 and performs multiple successive compressions or encodings to generate compressed encoded data 916 and compressed encoded data 918. Although only two instances of compressed encoded data 916, 918 are shown, any number of successive compressions or encodings can be employed until a desired lower dimension space for the latent code 940 is reached.

During training, the input 980 includes input domain labels 982 and input content labels 584 that are non-anomalous (e.g., non-task content labels 512 and non-task domain labels 514 shown in FIG. 5). During runtime, the input 980 includes runtime input data generated by a DCS (e.g., DCS 430 and DCS 522 shown in FIGS. 4 and 5) that is monitoring an SUA (e.g., the vehicle 120 show in FIG. 4 and/or the SUA 520 shown in FIG. 5.

The compressed encoded data 914 is analyzed by a domain disentanglement module 944 to disentangle domain features from the compressed encoded data 914 and generate content code 942. A self-supervised content pre-classification operation module 946 is used to identity similarities and differences among the content code 942. Similarly, the compressed encoded data 918 is analyzed by a content disentanglement module 946 to disentangle content features from the compressed encoded data 918 and generate domain code 952. A self-supervised domain pre-classification operation module 954 is used to identity similarities and differences among the domain code 952. Portions of the compressed encoded data 914, 918 that are not disentangled by the domain disentanglement module 944 and/or the content disentanglement module 946, if any, are captured as content and domain (C/D) code 958. A combine module 960 combines the content code 942, the C//D code 958, and the domain code 952 and provides the combined code to the decoder 970 where it is decompressed through successive decompressions 972, 974 to generate an output 990 having a reconstruction loss 992. During training of the CIDI neural network 450B, the reconstruction loss 992 is used to train the CIDI neural network 450B. During runtime, the reconstruction loss 992 is used to determine whether input 908 is normal or anomalous.

In some embodiments of the invention, the domain disentanglement module 944 can be implemented as an adversarial domain discriminator configured and trained to perform the task of disentangling domain features from the compressed encoded data 914 to generate the content code 942 that is domain irrelevant. In some embodiments of the invention, the content disentanglement module 946 can be implemented as an adversarial content discriminator configured and trained to perform the task of disentangling content features from the compressed encoded data 918 to generate the domain code 952 that is content irrelevant. In some embodiments of the invention, the self-supervised content pre-classification module 946 and/or the self-supervised domain pre-classification module 954 can be implemented using a classifier (a content classifier and a domain classifier) configured and trained to use contrastive self-learning techniques that have been trained to learn the general features of a dataset without labels by teaching the neural network model which data points are similar or different. In essence, contrastive self-learning allows a neural network model looks at which pairs of data points are “similar” and “different” in order to learn higher-level features about the data before even having a task such as classification or segmentation. This allows the neural network model to be trained to learn a lot about the data without any annotations or labels, hence the term, self-supervised learning.

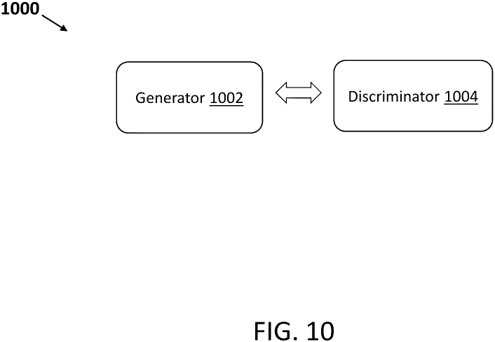

FIG. 10 depicts an example of an adversarial discriminator neural network 1000 that can be used to implement the adversarial discrimination functionality of the CIDI neural networks 450, 450A, 450B (shown in FIGS. 4, 5, and 9) and the methodologies 600, 700, 800 (shown in FIGS. 6, 7, and 8). The adversarial discriminator neural network 1000 includes a generator module 1002 and a discriminator module 1004. The adversarial discriminator neural network 1000 can be any one of a variety of types of adversarial discriminator neural networks that can be trained to test features of the encoded data (e.g., content features and/or domain features) and isolate the encoded data that has a selected feature but is irrelevant to non-selected features.

Additional details of machine learning techniques that can be used to implement aspects of the invention disclosed herein will now be provided. The various prediction and/or determination functionality of the processors described herein can be implemented using machine learning and/or natural language processing techniques. In general, machine learning techniques are run on so-called “neural networks,” which can be implemented as programmable computers operable to run sets of machine learning algorithms and/or natural language processing algorithms. Neural networks incorporate knowledge from a variety of disciplines, including neurophysiology, cognitive science/psychology, physics (statistical mechanics), control theory, computer science, artificial intelligence, statistics/mathematics, pattern recognition, computer vision, parallel processing and hardware (e.g., digital/analog/VLSI/optical).

The basic function of neural networks and their machine learning algorithms is to recognize patterns by interpreting unstructured sensor data through a kind of machine perception. Unstructured real-world data in its native form (e.g., images, sound, text, or time series data) is converted to a numerical form (e.g., a vector having magnitude and direction) that can be understood and manipulated by a computer. The machine learning algorithm performs multiple iterations of learning-based analysis on the real-world data vectors until patterns (or relationships) contained in the real-world data vectors are uncovered and learned. The learned patterns/relationships function as predictive models that can be used to perform a variety of tasks, including, for example, classification (or labeling) of real-world data and clustering of real-world data. Classification tasks often depend on the use of labeled datasets to train the neural network (i.e., the model) to recognize the correlation between labels and data. This is known as supervised learning. Examples of classification tasks include identifying objects in images (e.g., stop signs, pedestrians, lane markers, etc.), recognizing gestures in video, detecting voices, detecting voices in audio, identifying particular speakers, transcribing speech into text, and the like. Clustering tasks identify similarities between objects, which the clustering task groups according to those characteristics in common and which differentiate them from other groups of objects. These groups are known as “clusters.”

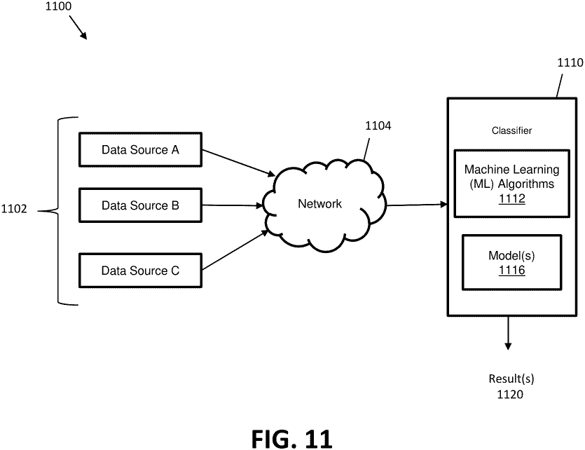

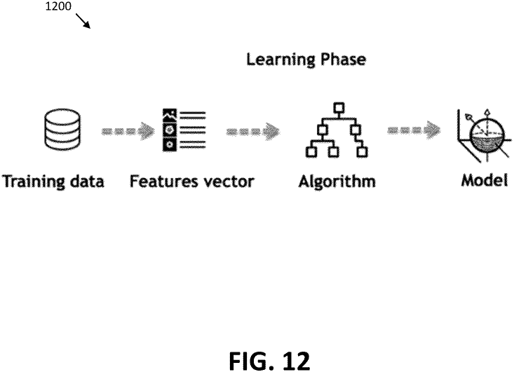

An example of machine learning techniques that can be used to implement aspects of the invention will be described with reference to FIGS. 11 and 12. FIG. 11 depicts a block diagram showing a classifier system 1100 capable of implementing various predicting and determining aspects of the invention described herein. More specifically, the functionality of the system 1100 is used in embodiments of the invention to generate various models and/or sub-models that can be used to implement predicting and determining functionality in embodiments of the invention. The classifier system 1100 includes multiple data sources 1102 in communication through a network 1104 with a classifier 1110. In some aspects of the invention, the data sources 1102 can bypass the network 1104 and feed directly into the classifier 1110. The data sources 1102 provide data/information inputs that will be evaluated by the classifier 1110 in accordance with embodiments of the invention. The data sources 1102 also provide data/information inputs that can be used by the classifier 1110 to train and/or update model(s) 1116 created by the classifier 1110. The data sources 1102 can be implemented as a wide variety of data sources, including but not limited to, sensors operable to gather real time data, data repositories (including training data repositories), and outputs from other classifiers. The network 1104 can be any type of communications network, including but not limited to local networks, wide area networks, private networks, the Internet, and the like.

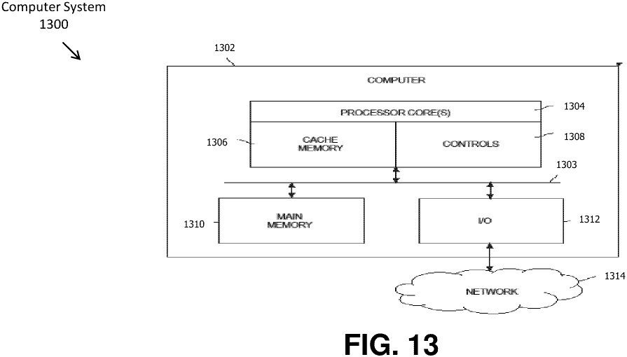

The classifier 1110 can be implemented as algorithms executed by a programmable computer such as the computing system 1300 (shown in FIG. 13). As shown in FIG. 11, the classifier 1110 includes a suite of machine learning (ML) algorithms 1112; and model(s) 1116 that are relationship (or prediction) algorithms generated (or learned) by the ML algorithms 1112. The algorithms 1112, 1116 of the classifier 1110 are depicted separately for ease of illustration and explanation. In embodiments of the invention, the functions performed by the various algorithms 1112, 1116 of the classifier 1110 can be distributed differently than shown. In some embodiments of the invention, natural language processing (NLP) algorithms can be integrated within the ML algorithms 1112.

Referring now to FIGS. 11 and 12 collectively, FIG. 12 depicts an example of a learning phase 1200 performed by the ML algorithms 1112 to generate the above-described models 1116. In the learning phase 1100, the classifier 1110 extracts features from the training data and coverts the features to vector representations that can be recognized and analyzed by the ML algorithms 1112. The features vectors are analyzed by the ML algorithm 1112 to “classify” the training data against the target model (or the model’s task) and uncover relationships between and among the classified training data. Examples of suitable implementations of the ML algorithms 1112 include but are not limited to neural networks, support vector machines (SVMs), logistic regression, decision trees, hidden Markov Models (HMMs), etc. The learning or training performed by the ML algorithms 1112 can be supervised, unsupervised, or a hybrid that includes aspects of supervised and unsupervised learning. Supervised learning is when training data is already available and classified/labeled. Unsupervised learning is when training data is not classified/labeled so must be developed through iterations of the classifier 1110 and the ML algorithms 1112. Unsupervised learning can utilize additional learning/training methods including, for example, clustering, anomaly detection, neural networks, deep learning, and the like.

When the models 1116 are sufficiently trained by the ML algorithms 1112, the data sources 1102 that generate “real world” data are accessed, and the “real world” data is applied to the models 1116 to generate usable versions of the results 1120. In some embodiments of the invention, the results 1120 can be fed back to the classifier 1110 and used by the ML algorithms 1112 as additional training data for updating and/or refining the models 1116.

FIG. 13 illustrates an example of a computer system 1300 that can be used to implement the computer-based components of the neural network system described herein. The computer system 1300 includes an exemplary computing device (“computer”) 1302 configured for performing various aspects of the content-based semantic monitoring operations described herein in accordance aspects of the invention. In addition to computer 1302, exemplary computer system 1300 includes network 1314, which connects computer 1302 to additional systems (not depicted) and can include one or more wide area networks (WANs) and/or local area networks (LANs) such as the Internet, intranet(s), and/or wireless communication network(s). Computer 1302 and additional system are in communication via network 1314, e.g., to communicate data between them.

Exemplary computer 1302 includes processor cores 1304, main memory (“memory”) 1310, and input/output component(s) 1312, which are in communication via bus 1303. Processor cores 1304 includes cache memory (“cache”) 1306 and controls 1308, which include branch prediction structures and associated search, hit, detect and update logic, which will be described in more detail below. Cache 1306 can include multiple cache levels (not depicted) that are on or off-chip from processor 1304. Memory 1310 can include various data stored therein, e.g., instructions, software, routines, etc., which, e.g., can be transferred to/from cache 1306 by controls 1308 for execution by processor 1304. Input/output component(s) 1312 can include one or more components that facilitate local and/or remote input/output operations to/from computer 1302, such as a display, keyboard, modem, network adapter, etc. (not depicted).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 14, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 14 are intended to be illustrative only and that computing nodes 10 and cloud computing environment 50 can communicate with any type of computerized device over any type of network and/or network addressable connection (e.g., using a web browser).

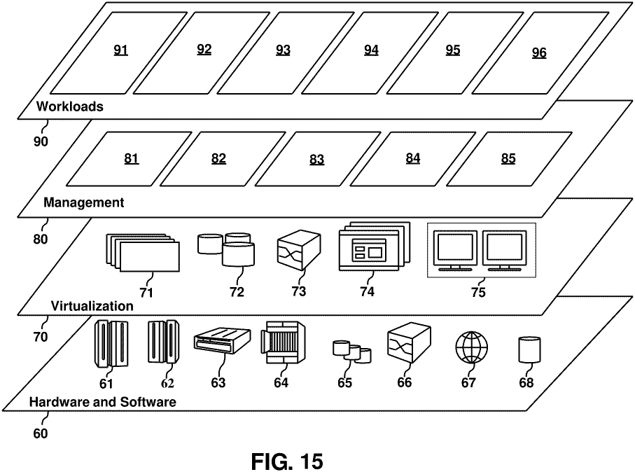

Referring now to FIG. 15, a set of functional abstraction layers provided by cloud computing environment 50 (FIG. 14) is shown. It should be understood in advance that the components, layers, and functions shown in FIG. 15 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and the CIDI neural network functionality 96.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” are understood to include any integer number greater than or equal to one, i.e. one, two, three, four, etc. The terms “a plurality” are understood to include any integer number greater than or equal to two, i.e. two, three, four, five, etc. The term “connection” can include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ± 8% or 5%, or 2% of a given value.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method of detecting anomalous data associated with a system-under-analysis, the computer-implemented method comprising:
using a first encoder stage of a neural network to generate content-irrelevant latent code from input data;
using a second encoder stage of the neural network to generate domain-irrelevant latent code from the input data;
using a decoder stage of the neural network to generate reconstructed input data;
wherein the reconstructed input data comprises a reconstruction of the input data based at least in part on the content-irrelevant latent code and the domain-irrelevant latent code;
generating a reconstruction loss based at least in part on the reconstructed input data; and
using the reconstruction loss to determine that the input data comprises an anomalous data candidate.

2. The computer-implemented method of claim 1, wherein:
the first encoder stage generating the content-irrelevant latent code comprises identifying similarities and differences among the content-irrelevant latent code; and
the second encoder stage generating the domain-irrelevant latent code comprises identifying similarities and differences among the domain-irrelevant latent code.

3. The computer-implemented method of claim 1 further comprising using the first encoder stage of the neural network to generate content-irrelevant and domain-irrelevant (CIDI) latent code from the input data.

4. The computer-implemented method of claim 3, wherein the reconstruction of the input data is also based at least in part on the CIDI latent code.

5. The computer-implemented method of claim 1, wherein the neural network has been trained to:
disentangle the content-irrelevant code from the input data; and
disentangle the domain-irrelevant code from the input data.

6. The computer-implemented method of claim 5, wherein:
an adversarial content discriminator has been used to train the neural network to disentangle the content-irrelevant code from the input data; and
an adversarial domain discriminator has been used to train the neural network to disentangle the domain-irrelevant code from the input data.

7. The computer-implemented method of claim 2, wherein:
the first encoder stage of the neural network has been trained to identify similarities and differences among the content-irrelevant latent code; and
the second encoder stage of the neural network has been trained to identify similarities and differences among the domain-irrelevant latent code.

8. A computer system for detecting anomalous data associated with a system-under-analysis, the computer system comprising:
a memory; and
a processor communicatively coupled to the memory, wherein the processor is operable to perform operations comprising:
using a first encoder stage of a neural network to generate content-irrelevant latent code from input data;
using a second encoder stage of the neural network to generate domain-irrelevant latent code from the input data;
using a decoder stage of the neural network to generate reconstructed input data;
wherein the reconstructed input data comprises a reconstruction of the input data based at least in part on the content-irrelevant latent code and the domain-irrelevant latent code;
generating a reconstruction loss based at least in part on the reconstructed input data; and
using the reconstruction loss to determine that the input data comprises an anomalous data candidate.

9. The computer system of claim 8, wherein:
the first encoder stage generating the content-irrelevant latent code comprises identifying similarities and differences among the content-irrelevant latent code; and
the second encoder stage generating the domain-irrelevant latent code comprises identifying similarities and differences among the domain-irrelevant latent code.

10. The computer system of claim 8, wherein the operations further comprise using the first encoder stage of the neural network to generate content-irrelevant and domain-irrelevant (CIDI) latent code from the input data.

11. The computer system of claim 10, wherein the reconstruction of the input data is also based at least in part on the CIDI latent code.

12. The computer system of claim 8, wherein the neural network has been trained to:
disentangle the content-irrelevant code from the input data; and
disentangle the domain-irrelevant code from the input data.

13. The computer system of claim 12, wherein:
an adversarial content discriminator has been used to train the neural network to disentangle the content-irrelevant code from the input data; and
an adversarial domain discriminator has been used to train the neural network to disentangle the domain-irrelevant code from the input data.

14. The computer system of claim 9, wherein:
the first encoder stage of the neural network has been trained to identify similarities and differences among the content-irrelevant latent code; and
the second encoder stage of the neural network has been trained to identify similarities and differences among the domain-irrelevant latent code.

15. A computer program product for detecting anomalous data associated with a system-under-analysis, the computer program product comprising a computer readable storage medium having program instructions embodied therewith, the program instructions executable by a processor system to cause the processor system to perform operations comprising:
using a first encoder stage of a neural network to generate content-irrelevant latent code from input data;
using a second encoder stage of the neural network to generate domain-irrelevant latent code from the input data;
using a decoder stage of the neural network to generate reconstructed input data;
wherein the reconstructed input data comprises a reconstruction of the input data based at least in part on the content-irrelevant latent code and the domain-irrelevant latent code;
generating a reconstruction loss based at least in part on the reconstructed input data; and
using the reconstruction loss to determine that the input data comprises an anomalous data candidate.

16. The computer program product of claim 15, wherein:
the first encoder stage generating the content-irrelevant latent code comprises identifying similarities and differences among the content-irrelevant latent code; and
the second encoder stage generating the domain-irrelevant latent code comprises identifying similarities and differences among the domain-irrelevant latent code.

17. The computer program product of claim 15, wherein the operations further comprise using the first encoder stage of the neural network to generate content-irrelevant and domain-irrelevant (CIDI) latent code from the input data.

18. The computer program product of claim 17, wherein the reconstruction of the input data is also based at least in part on the CIDI latent code.

19. The computer program product of claim 15, wherein:
the neural network has been trained to:
disentangle the content-irrelevant code from the input data; and
disentangle the domain-irrelevant code from the input data;
an adversarial content discriminator has been used to train the neural network to disentangle the content-irrelevant code from the input data; and
an adversarial domain discriminator has been used to train the neural network to disentangle the domain-irrelevant code from the input data.

20. The computer program product of claim 15, wherein:
the first encoder stage of the neural network has been trained to identify similarities and differences among the content-irrelevant latent code; and
the second encoder stage of the neural network has been trained to identify similarities and differences among the domain-irrelevant latent code.
